(19) United States
(12) Patent Application Publication
(10) Pub. No.: US 2010/0200607 A1
(43) Pub. Date: Aug. 12, 2010

(54) EXTRACTOR SYSTEM FOR CANS AND BOTTLES FOR DISPENSING MACHINES

(76) Inventor: Felix Guindulain Busto, Peralta-Navarra (ES)

Correspondence Address: OSTROLENK FABER GERB & SOFFEN, 1180 AVENUE OF THE AMERICAS, NEW YORK, NY, 100368403, US

(21) Appl. No.: 12/668,505

(22) PCT Filed: Jul. 14, 2008
(86) PCT No.: PCT/ES2008/070138

§ 371 Date: Mar. 11, 2010

(30) Foreign Application Priority Data
Jul. 12, 2007 (ES) P200701953

(51) Int. Cl. G07F 11/24

(52) U.S. Cl. 221/277

(57) ABSTRACT

Extractor system for cans and bottles for dispensing machines, useful in all types of coin-operated can and bottle dispensing machines, wherein the cans or bottles are stored in a compartment in columns arranged in two rows in quincunxes and wherein the lowest can or bottle is supported on the extractor mechanism itself in the rest position thereof and which when rotated enables the exit of the can or bottle between the former and the lowest side of the lateral wall of the storage compartment, comprising a first stationary axle; a second axle with a polygonal cross-section and a number of cams fitted on the second polygonal axle and associated with each of the unitary extractor mechanisms through a housing.

### OBJECT OF THE INVENTION

The following invention, as stated in the heading of the present specification relates to an extractor system for cans and bottles for dispensing machines, being the coin-operated type of dispensing machines, having the object of allowing the cans or bottles to be stacked in quincunxes, the lowest product supported on the extractor mechanism, arranged at least in two columns stacked in quincunxes, optimizing the space.

The columns stacked in quincunxes is supported, by the lowest product, on the extractor system in staggered position from one another, so that the controlled swinging displacement of the extractor system causes the successive and alternative unitary expulsion of the cans or bottles from the different columns with the products stacked in quincunxes.

### FIELD OF APPLICATION

The present specification discloses an extractor system for cans and bottles for dispensing machines, being useful in automatic dispensing machines which incorporate a cooling apparatus and are actuated by inserting coins, being especially useful for dispensing water bottles deposited in quincunxes in the storage compartments.

### BACKGROUND OF THE INVENTION

As is known in the market there are different models of coin-operated dispensing machines, so that making reference to cold drink dispensing machines, they must incorporate a cooling apparatus to keep the drinks at the right temperature for their consumption.

Thus, we can consider Invention Patent P8902020 disclosing a machine supplying and cooling drink containers, which comprises a series of shelves fixed by one of their two lateral sides, so that when empty they are in a practically horizontal position and when loaded with the containers they undergo an inclination so that, as there is a flange at its lower free end, they act as a buffer of the containers of the lowest shelf meaning that the containers are extracted from the upper shelf to the lowest shelf.

Likewise, we can cite Invention Patent P9002132 disclosing a dispensing machine, which is formed by a series of parallel circular compartments, the cans being deposited on rotating platforms individually embedded in its central drive shaft, whilst in its upper part it has a second stationary platform equipped with a strip which defines a spiral conduit for positioning the cans, so that the rotation of the lowest platform causes the exit of the cans.

Likewise, we can consider Invention Patent ES 2113824 disclosing a dispensing machine of cylindrical products, so that the products are stored in a series of stationary shelves inclined downwards and towards a guide conduit of the products to the extractor mechanism, the products being extracted from the upper shelf to the lowest shelf.

Finally, we can consider Invention Patents ES 9900290 and ES 200000259 disclosing an extractor mechanism for dispensing machines, so that in both the extractor mechanism is based on a shaft whereto is fixed at least one housing in general cylindrical shape, the lowest product being supported on its curved surface, so that document ES 9900290 specifies that the distance between the curved surface and the lowest part of the storage walls is less than their diameter and when rotated, as it coincides with the flat surface, allows the exit of the lowest product.

On the other hand, document ES 200000259 specifies that in its rotation of the retaining element of the lowest product, it can rotate in both directions, alternatively rotating in one direction and another from an intermediate position enabling the exit of a container belonging to different stacked columns.

We can also cite documents U.S. Pat. No. 4,768,680, U.S. Pat. No. 5,799,823 and U.S. Pat. No. 5,893,482, so that document U.S. Pat. No. 4,768,680 discloses a container wherein the products are stacked in individual compartments in pairs and are dispensed by a single mechanism of alternative rotating direction, whilst document U.S. Pat. No. 5,799,823 and U.S. Pat. No. 5,893,482 disclose extractor mechanisms whereon the products stacked in quincunxes are supported and in their actuation enable the alternative exit of the products from the two columns of products to be dispensed stored in quincunxes.

### DESCRIPTION OF THE INVENTION

The present specification discloses an extractor system for cans and bottles for dispensing machines, being coin-operated type dispensing machines, having the object of making it possible to stack the cans or bottles in columns arranged in two rows in quincunxes and wherein the lowest product is supported on the extractor mechanism, so that the system comprises:

a first stationary axle wherein are fitted, close to one of its vertices and in staggered position, at least two extractor mechanisms formed by housings of general triangular shape the side opposite the assembly vertex with free rotation having a general convex shape;

a second axle with a polygonal cross section, passing through a curved slit orifice of the housings fitted with free rotation on the first axle;

a number of cams fitted on the second polygonal axle associated with each of the extractor mechanisms formed by housings of general triangular shape fitted on the first axle, wherein cams are equipped with an axial circular projection;

the housings of general triangular shape have on one of their sides a closed curved slot, in position transversal to the through orifice;

the axial circular projection of each of the cams fitting in the closed curved slot of the respective housing of general triangular shape associated to it.

Furthermore, the first axle which fits the unitary extractor mechanisms bears the weight of the cans and the second axle, in its actuation on the cams, causes the dispensing of the cans.

In addition, the first axle and the second axle may be supported and guided by a through strip and free rotation of both, so that in this way a possible warping is avoided, mainly of the first axle that bears the weight of the products, as well as the impact on its dropping when one is dispensed.

The diameter of the axial circular projection of the cams has a diameter slightly greater than the width of the through orifice of the first axle made in the housings of general triangular shape fitted, with free rotation, on the first axle and wherein the axial projection of the cams fits in the respective closed curved slot of the housing fitted on the first axle associated to it, enabling the axial circular projection of the cams to pass through the through orifice of the housings of general triangular shape in their sliding through the slot transversal to it, giving it a swinging movement.

On the other hand, the cams have a through orifice which anchors the second star-shaped axle with a variable number of points for an adjustable fitting, enabling the assembly of the cams according to different angles.

Thus, in a preferred embodiment of then invention, the star-shaped through orifice of the cams, which anchors the second axle, will have eight points enabling an adjustable positioning, according to different angles, so that they will facilitate the assembly of four unitary extractor mechanisms, the cams being positioned 45° from one another.

To the rotation axis of the second axle is associated a toothed circular housing whereto the motor transmits movement and from the circular housing whereof arises a tubular piece wherein the external surface has axial projections arranged at two different heights, alternate, whereto, according to their height, is associated a control micro of the rotation angle, so that according to the number of unitary extractor mechanisms, preferably, two or four are placed in relation to some projections or others.

To complement the description that will be made below and in order to aid towards a better understanding of the characteristics of the invention, a set of plans is attached to the present specification, the figures whereof illustratively and non-limitatively represent the most characteristic details of the invention.

### BRIEF DESCRIPTION OF THE DRAWINGS

FIG. 1. Shows a perspective detailed view of the extractor system defined by unitary extractor mechanisms whereon the products shall be supported, it being possible to observe how it, in the represented embodiment, shall have four columns of products arranged in two rows in quincunxes, as well as the toothed circular housing solidly joined to the second polygonal axle and wherefrom arises a tubular part with projections on its external surface whereon the rotation control micro acts.

FIG. 2. Shows a view of detail A of the previous figure relating to the toothed circular housing solidly joined to the second polygonal axle, from the housing whereof arises a tubular part with external projections whereon the rotation control micro acts, having represented two micros according to its position for the dispensing of four or eight products, i.e. two or four columns.

FIG. 3. Shows a front view of the extractor system in accordance with four unitary extractor mechanisms, it being possible to observe how they are positioned according to different angles to enable the successive and alternative exit of products, as well as the toothed circular housing to transmit movement and rotation control by means of the respective micro.

FIG. 4. Shows a first perspective view of a housing of general triangular shape which is fitted on a first axle with free rotation and which is equipped with a through slit orifice and a curved slot transversal to said through orifice.

FIG. 5. Shows a second perspective view of the housing of the previous figure.

FIG. 6. Shows a third perspective view of the housing of 4 by its opposite side.

FIG. 7. Shows a side elevation view of the arrangement of the housings of general triangular shape fitted, with free rotation, on a first axle and the drag cam of one of them.

FIG. 8. Shows a view of detail B of the previous figure it being possible to observe the staggered arrangement of the housings of general triangular shape fitted, with free rotation, on a first axle and the drag cam of one of them, so that the cam is fitted on a second polygonal axle, whose polygonal axle passes through the through orifice of the housings of general triangular shape fitted on the first axle with free rotation.

FIG. 9. Shows a perspective view of a cam, it being possible to observe the polygonal assembly orifice in the second axle and the axial circular projection which is fitted in the closed curved slot of the respective housing of general triangular shape fitted with free rotation on the first axle for the swinging movement thereof.

FIG. 10. Shows a lateral elevation view of the movement of a unitary extractor mechanism formed based on housings of general triangular shape dragged by a cam which rotates anticlockwise, it being possible to observe how the cans stacked in quincunxes are extracted.

### DESCRIPTION OF A PREFERRED EMBODIMENT

In light of said figures and in accordance with the numbering adopted, we can observe how the extractor system shall be useful in all types of coin-operated can and bottle dispensing machines, wherein the cans or bottles 3 are stored in a compartment 1 in columns arranged in two rows in quincunxes and wherein the lowest can or bottle 3 is supported on the extractor mechanism itself in its rest position and which, when rotated, enables the exit of the can or bottle between it and the lower side, from one side or the other, of the lateral wall 2 of the storage compartment 1.

Starting from this known embodiment, the system is formed by a first stationary axle 4 wherein are fitted, close to one of its vertices and in staggered position, at least two unitary extractor mechanisms formed by one or more housings 5 the side opposite the assembly vertex on the first axle with free rotation having a general convex shape 6, whereon the cans or bottles to be dispensed are supported.

On the other hand, the first axle 4 which fits the unitary extractor mechanisms bears the weight of the cans and the second axle 7, in its actuation on the cams 10, causes the dispensing of the cans.

Furthermore, the first axle 4 and the second axle 7 may be supported and guided by a through strip 21 and of free rotation of both, whereby an attempt is made to avoid a possible warping, mainly, of the first axle 4.

Thus, the housings 5 of general triangular shape have a through orifice 19 of the first axle 4, being fitted with free rotation.

Furthermore, the number of housings 5 forming a unitary extractor mechanism shall be determined by the height of the can or bottles to be dispensed thereby.

Likewise, the system has a second axle 7, with a polygonal cross section, passing through a curved slit orifice 8 of the housings 5 fitted with free rotation on the first axle 4, on whose second polygonal axle 7 are mounted a number of cams 10 associated with a housing 5 of each of the unitary extractor mechanisms fitted on the first axle 4, so that said cams 10 are equipped with a circular axial projection 11.

On the other hand, the housings 5 of general triangular shape forming the unitary extractor mechanisms have on one of their sides a curved closed slot 9, in position transversal to the through orifice 8, so that the circular axial projection 11 of the respective cam 10 associated to the respective housing 5 fits in said closed curved slot 9.

Therefore, the diameter of the circular axial projection 11 of the cams 10 has a diameter slightly greater than the width of the through orifice 8 made in the housings 5 of general triangular shape fitted, with free rotation, on the first axle 4 and wherein the axial projection 11 of the cams 10 fits in the respective curved closed slot 9 of the respective housing 5 fitted on the first axle 4 associated to it.

The cams 10 have a through orifice 12 which anchors the second star-shaped axle 7 with a variable number of points for an adjustable fitting, enabling the cams 10 to be fitted according to different angles.

Thus, in a preferred embodiment of the invention, the star-shaped through orifice 12 of the cams 10, which anchors the second axle 7, has eight points and as the second polygonal axle 7 has a square section it allows an adjustable positioning, according to four positions at 45°, so that in this case it is possible to dispense eight products in a 360° rotation of the second axle 7, i.e. of the cams 10.

On the other hand, to the second polygonal axle 7 is associated a toothed circular housing 13 wherefrom arises a tubular rib 14 with axial projections 15 and 16 on its external surface arranged at two different heights, alternate, whereto, according to its height, is associated a control micro 17 or 18 of the rotation angle of said second polygonal axle 7.

Thus, in the gear wheel 13 gears a pinion transmitting the movement of the drive motor 20.

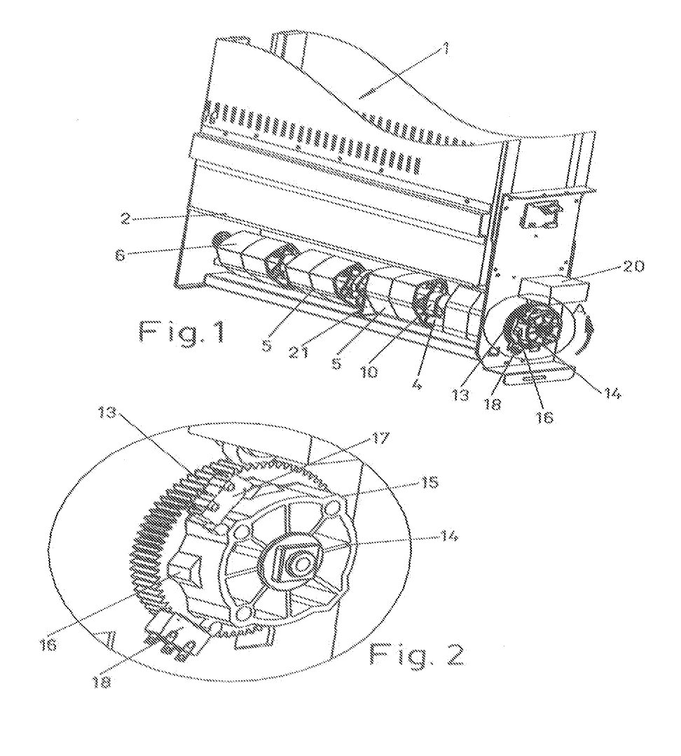

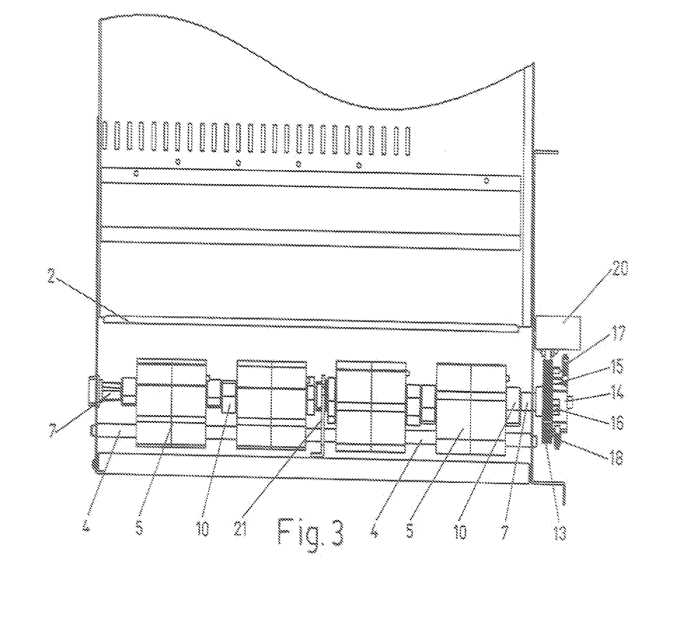

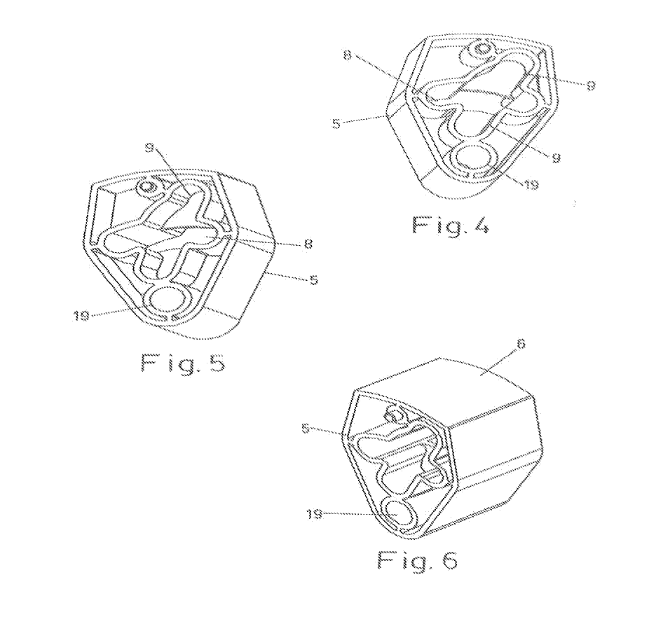

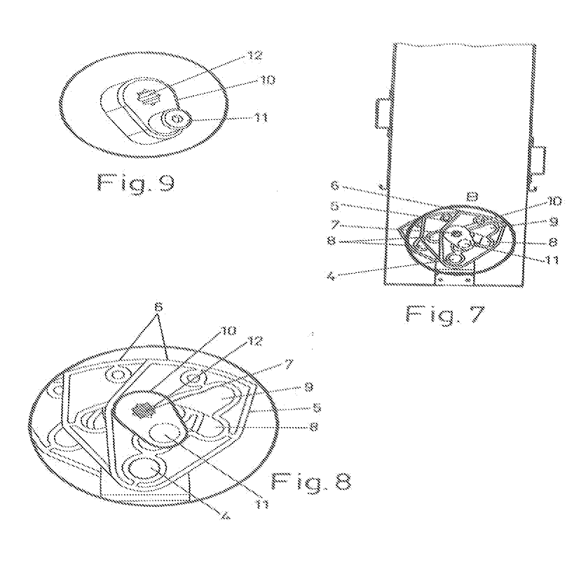

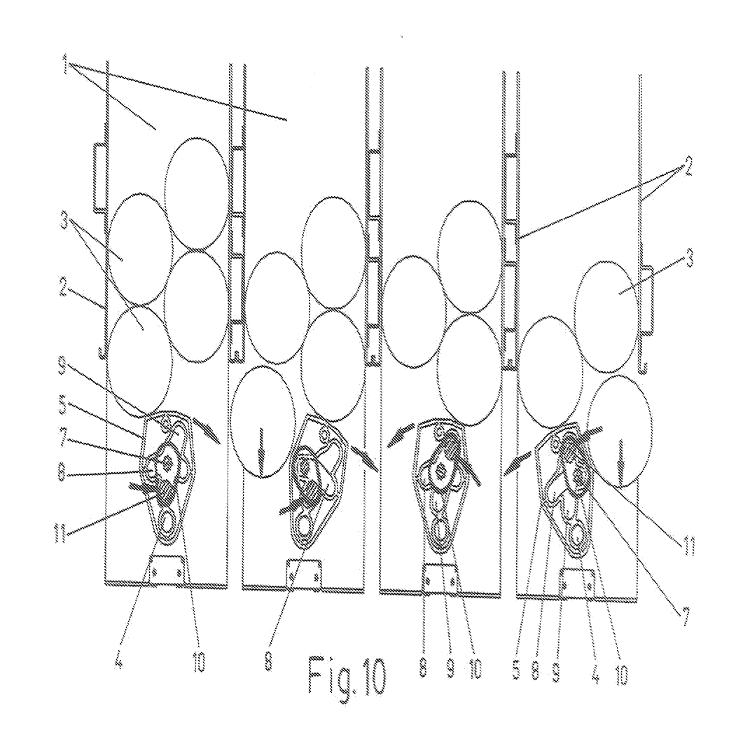

FIG. 1 of the designs represents an extractor system formed by four unitary extractor mechanisms formed by the joining of two housings 5 of general triangular shape and fitted with free rotation on the first axle 4 through the orifice 19, which will allow the storage of four columns of cans or bottles 3 arranged in two rows in quincunxes, as observed in FIG. 10 of the designs.

The cans or bottles 3 are stacked on the convex surface 6 of the housings 5 and with swinging rotation of said housings 5 produces the successive extraction of the different unitary extractor mechanisms and alternates to one side and the other thereof.

The housings 5 of general triangular shape, fitted with free rotation on the first axle 4, are actuated by the respective cam 10 fitted on the second polygonal axle 7 which transmits the movement when the axial projection 11 of the cams 10 fits in the closed slot 9 of the housings 5, whilst the second assembly axle 7 of the cams 10 passes through the through orifice 8 of the housings 5.

Thus, as the cams 10 are fitted in staggered position the rotation of the axle 7 whereon they are fitted makes them drag the respective housings 5 associated thereto, so that a can or bottle 3 is dispensed from the successive unitary extractor mechanisms on the one side and the cans or bottles with be dispensed through the other side, i.e. of one row and then from the other row of the respective stacked column.

In this way, FIG. 10 of the designs has represented a cycle of an extractor mechanisms where the anticlockwise rotation of the cam 10 makes the projection 11 displace through the slot 9 dragging the housing 5 in a swinging movement which causes the dispensing of a can through one side and then through the other.

Logically, the number of unitary extractor mechanisms shall be variable and, preferably, the dispensing machines, depending on the height of the cans or bottles, shall have two or four, and the rotation angle of the second axle 7 which transmits the movement to the drag cams 10 of the housings 5 forming the extractor mechanisms shall be determined depending on them.

Making reference to the figures, the cams 10 shall be fitted staggered 45° from one another, so that each rotation of the second polygonal axle 7, in anticlockwise direction, shall cause the successive dispensing of a can or bottle from the unitary extractor mechanisms and then, when rotated, the cans or bottles shall be dispensed through the other side.

Furthermore, the configuration of the projection 14 of the gear wheel 13 with the ribs 15 and 16 of different height makes it possible to position a micro 17 or 18 with relation to one or another that controls the rotation of the second drive axle 7 according to an angle of 90° or 45°, depending on whether the products to be dispensed are four of eight.

In the example of the designs, the micro to fit shall be the micro 18 that shall control the rotation of the second drive axle 7 according to a 45° angle.

Logically, the number of extractor mechanisms the respective dispensing machine incorporates can be variable, so that it can also incorporate a single unitary extractor mechanism, based on an identical structure.

1. An extractor system for cans and bottles for dispensing machines, the extractor system shall be useful in all types of coin-operated can and bottle dispensing machines, wherein the cans or bottles are stored in a compartment in columns arranged in two rows in quincunxes and wherein the lowest can or bottle is supported on the extractor mechanism itself in the rest position thereof and which when rotated enables the exit of the can or bottle between the former and the lowest side of the lateral wall of the storage compartment, characterized in that the system comprises:
a first stationary axle wherein are fitted, close to one of its vertices and in staggered position, at least two unitary extractor mechanisms formed by at least one housing of general triangular shape the side opposite the assembly vertex with free rotation having a general convex shape;
a second axle, with a polygonal cross section, passing through a curved slit orifice of the housings fitted with free rotation on the first axle;
a number of cams fitted on the second polygonal axle and associated with each of the unitary extractor mechanisms through a housing of general triangular shape, fitted on the first axle, wherein the cams are equipped with an axial circular projection;
the housings of general triangular shape have on one of their sides a closed curved slot, in position transversal to the through orifice;
the axial circular projection of each of the cams fitting in the closed curved slot of the respective housing of general triangular shape associated to it.

2. The extractor system for cans and bottles for dispensing machines according to claim 1, wherein the first axle which fits the unitary extractor mechanisms bears the weight of the cans and the second axle, in its actuation on the cams, causes the dispensing of the cans.

3. The extractor system for cans and bottles for dispensing machines according to claim 1, wherein the first axle and the second axle may be supported and guided by a through strip and of free rotation of both.

4. The extractor system for cans and bottles for dispensing machines according to claim 1, wherein the diameter of the axial circular projection of the cams has a diameter slightly greater than the width of the through orifice made in the housings of general triangular shape fitted, with free rotation, on the first axle and wherein the axial projection of the cams fits in the respective closed curved slot of the housing fitted on the first axle associated to it.

5. The extractor system for cans and bottles for dispensing machines according to claim 1, wherein the cams have a through orifice which anchors the second star-shaped axle, with a variable number of points for an adjustable fitting.

6. The extractor system for cans and bottles for dispensing machines according to claim 1, wherein the star-shaped through orifice of the cams which anchors the second polygonal axle, has eight points enabling an adjustable positioning, according to different angles.

7. The extractor system for cans and bottles for dispensing machines according to claim 1, wherein a toothed circular housing is associated to the second polygonal axle, whereto a motor transmits movement, and from the housing whereof arises a tubular projection with axial ribs on its external surface arranged at two different heights, alternate, whereto, according to its height, is associated a control micro of the rotation angle.
